(19) United States
(12) Patent Application Publication
(10) Pub. No.: US 2010/0007490 A1
(43) Pub. Date: Jan. 14, 2010

(54) METHOD AND DEVICE FOR MONITORING THE EMISSION SITUATION OF A PLANT

(76) Inventor: Andreas Kochenburger, Eggenstein (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/309,373

(22) PCT Filed: Jan. 31, 2007
(86) PCT No.: PCT/EP2007/050949

§ 371 Date: Aug. 25, 2009

(30) Foreign Application Priority Data
Jul. 19, 2006 (EP) 06015048.9

(51) Int. Cl. G08B 21/00

(52) U.S. Cl. 340/540

(57) ABSTRACT

The invention relates to a method and device for monitoring the emission situation of a plant emitting emissions, comprising determination of at least one current emission value for the plant, extrapolation to a predicted emission value base on the at least one determined emission value, comparison of the predicted emission value with a given permitted emission and analysis of the comparison as basis for further regulation of the plant.

### CROSS REFERENCE TO RELATED APPLICATIONS

This application is the US National Stage of International Application No. PCT/EP2007/050949, filed Jan. 31, 2007 and claims the benefit thereof. The International Application claims the benefits of European application No. 06015048.9 filed Jul. 19, 2006, both of the applications are incorporated by reference herein in their entirety.

### FIELD OF THE INVENTION

The invention relates to a method and a device for monitoring the emission situation of a plant emitting emissions, in particular a power plant.

### BACKGROUND OF THE INVENTION

Pursuant to the legislation of the European Union on trading in greenhouse gas emission rights, since 2005 all operators of plants which emit greenhouse gases (in particular carbon dioxide (CO₂)), are obliged a) to register their plants and to request emission rights (certificates), b) to record their emission values and to report them annually, and c) to submit a corresponding quantity of certificates for the determined green house gas quantities.

In the case of the excessive emission of greenhouse gases, the operator has the right to acquire certificates retrospectively on the free market, or he/she must contend with considerable penalties and consequences in terms of the further operation of the plant. A surplus of certificates can be sold freely.

As a result of the highly volatile market prices for certificates, the emission of greenhouse gases and the associated trade in certificates involves a high entrepreneurial risk. It may also result in an unwanted correction and/or reassignment of certificates for instance if an operator does not reach his/her declared production quantity of greenhouse gas (so-called ex-post correction). This effectively means a loss of emission rights in the future, which could considerably increase the future costs for the operation of a plant.

So-called Compliance Management Software Systems are known, which are used to assist with emission reporting and certificate portfolio management. By inputting scenario data, these systems also assist with the evaluation of production and trade options.

### SUMMARY OF THE INVENTION

By comparison with these known systems, it is an object of the invention to specify a method and a device, by means of which the necessary control and regulation interventions at the associated plant can be identified immediately. The invention is to result in a reduction in personnel and if necessary in a saving in terms of compliance management.

The object is achieved in accordance with the invention with a method and a device as claimed in the independent claims. Advantageous developments of the invention are defined in the dependent claims.

According to the invention, a method for monitoring the emission situation of a plant emitting emissions is created, which includes the following steps: determining at least one current emission value of the plant, extrapolating to a predicted emission value on the basis of the at least one determined emission value, comparing the predicted emission value with an assigned emission right and evaluating the comparison as a basis for further regulation of the plant.

An early warning is also preferably provided, which indicates an expected shortfall in emission rights below a predefined threshold value. Alternatively or in addition, an expected surplus of emission rights above a predefined threshold value is indicated by means of an early warning.

These early warnings are advantageously indicated by means of traffic lights, with it being possible for a good complete overview to be created at the same time, particularly for several plants, by means of several consecutively arranged traffic lights. The color red is to be used here to indicate a shortfall in emission rights.

The early warning is preferably to be automatically transmitted and displayed by way of a wireless remote transmission. Approved standards for e-mail (Electronic Mail) and/or SMS (Short Message Service) are preferably used here.

The early warning is also to include a display of the progression of at least one current emission value and/or a display of the progression of the predicted emission value and/or a display of the progression of the assigned emission right.

It is also preferred in accordance with the invention for the early warning to include a display of further technical data of the plant to be monitored, in particular a display of the energy quantity generated with the plant.

The inventive solution is also achieved with a device for monitoring the emission situation of a plant emitting emissions, which includes a determination device for determining at least one current emission value of the plant, a computing device for extrapolating to a predicted emission value on the basis of the at least one determined emission value, a comparison device for comparing the predicted emission value with an assigned emission right and an evaluation device for evaluating the comparison as a basis for further regulation of the plant.

The device also preferably includes an early warning device for generating an early warning, which indicates an expected shortfall in emission rights below a predefined threshold value.

Alternatively or in addition, an early warning device is provided to generate an early warning, which indicates an expected surplus of emission rights above a predefined threshold value.

An traffic light device is also advantageously provided to display the early warning.

The early warning is preferably transmitted automatically and wirelessly, as mentioned above.

With the inventive device, a display is also preferably provided, with which aside from the early warning, the progression of the at least one current emission value and/or the progression of the predicted emission value and/or the progression of the assigned emission right can be indicated.

A display is also preferred with which aside from the early warning, further technical data of the plant to be monitored, in particular the energy quantity generated with the plant, can be indicated.

In this way, an integrated, holistic representation of the emission situation is created in accordance with the invention in particular together with production data, which is not immediately significant, but is of particular importance to the situation in respect of the greenhouse gas emission law. In accordance with the invention, data relating to the dust load, heavy metal load or heating of river water which is relevant to the law is indicated together with the data relating to maintenance planning, audit planning or district heat generation. Maintenance and audits can then be more effectively planned by using the evaluation of the emission values and can be integrated in the overall operation of the plant. To achieve this type of overall plant control, the most varied of forms of representation are used, in particular colored curves of the progressions, as well as calculation sequences, which are geared to national and international standards.

The inventive solutions permit a fast entrepreneurial decision using the created indication and early warning in real-time, in particular a prompt purchase and a prompt restructuring of certificates while prices are still favorable. Furthermore, a rapid, impartial distribution of the relevant information to all operators of a plant and employees involved is possible. The inventive type of evaluation and display of relevant data thus signifies a time saving compared with conventional systems.

### BRIEF DESCRIPTION OF THE DRAWINGS

An exemplary embodiment of an inventive method for monitoring the emission situation of a plant emitting emissions as well as an associated inventive device is described in more detail below with reference to the appended schematic drawings, in which;

FIG. 1 shows a highly schematic representation of a first exemplary embodiment of a device according to the invention;

FIG. 2 shows a screen view of a program for running the inventive method in a plant according to FIG. 1,

FIG. 3 shows a further screen view of the afore-cited program,

FIG. 4 shows a further screen view of the afore-cited program in the case of a second exemplary embodiment of a device according to the invention.

### DETAILED DESCRIPTION OF THE INTENTION

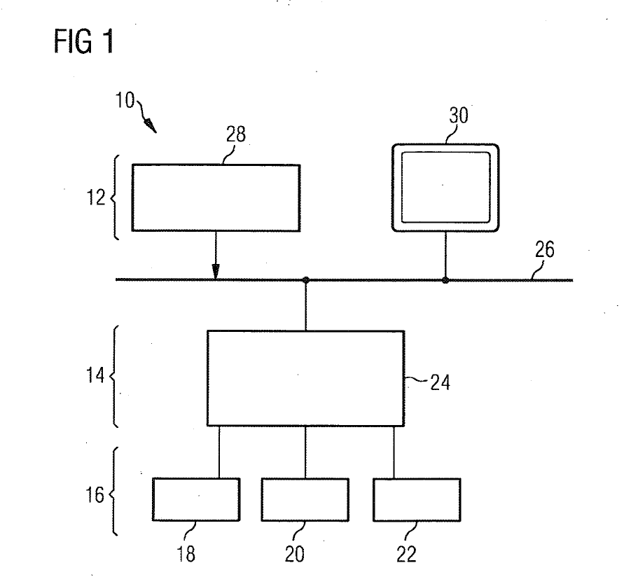

FIG. 1 shows the essential components of a device 10 for monitoring the emission situation of a plant emitting emissions. These are divided into three hierarchical levels 12, 14, 16, with the lowest level 16 including secondary systems of fuel data determination 18, activity data determination 20 and the storage 22 of inventory data on certificates. The collected data originates here from one or several monitored plants or from third party systems.

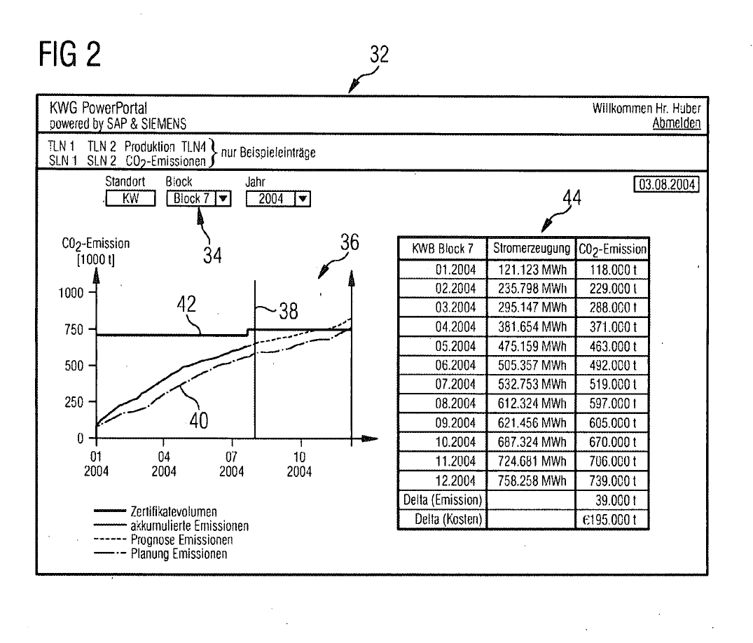

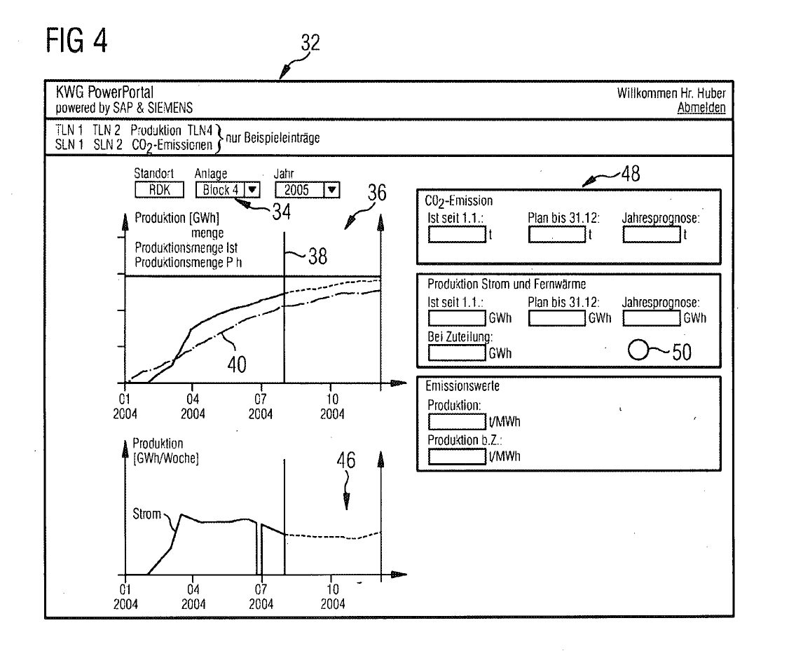

Data from this level 16 is processed further in the level 14 in a cockpit server 24, with in particular a signal preprocessor, an emission calculation, a time series combination and a report being generated. The cockpit-server 24 is connected to a portal server 28 by way of a company data line 26 and/or a data bus (local area network (LAN)), said portal server 28 including in particular a visualization, a messaging (reporting and displays) as well as a rights management in a computing unit, to which a screen 30 is coupled in an operational fashion. Displays are generated on this screen, as are shown in FIG. 2 to 4.

These displays include a navigation bar 32 in each instance, the content of which is dependent on the access rights of the registered user (in this case Mr. Huber). Selection boxes 34 for plant and year are possible (historically, currently and in the future) using the navigation bar 32.

A diagram 36 located in the left area of the display according to FIG. 2 contains a representation of the emission situation of the given plant. It has a vertical line 38; real historical data can be seen left of this line 38 as a curve 40, whereas right of the line 38 planning data and/or emission progressions calculated from a consumption schedule are shown as a continuation of the curve 40. A line 42 which is stepped horizontally across the curve 40 shows the stock of certificates in the business. The step means that certificates were bought later or restructured within the company.

Numerical values per month as well as a predicted overall shortfall on December 31 of the year are shown in a table 44 on the right next to the diagram 36.

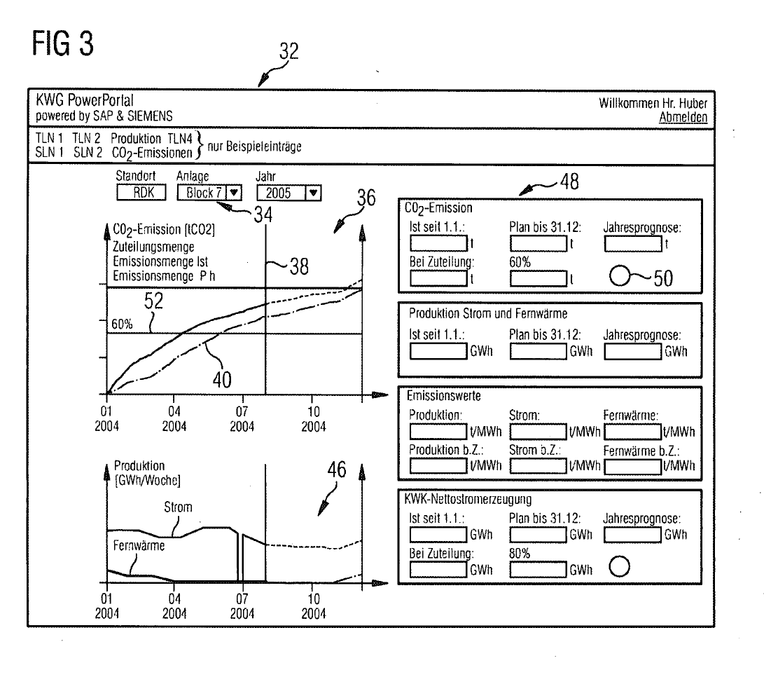

FIG. 3 shows a screen view, with which a given electricity and district heat generation is also shown as diagram 46 using diagram 36 which corresponds to that of FIG. 2 in terms of content. Other technical data of the given system can also be displayed instead of or underneath this diagram 46, said data not relating to greenhouse gases, e.g. other environmental stresses. Several display boxes 48 are shown on the right next to diagrams 36 and 46, said display boxes partially showing traffic light displays 50. The type and scope of these display boxes 48 is dependent on the allocation rules which are valid for the relevant plant. A distinction is thus provided between declared and historical emissions in the case of old plants, particularly in accordance with the German allocation law for certificates. Special rules apply to combined heat and power generation. The algorithms of the traffic light displays 50 vary depending on the plant, in particular in order to register impending ex-post corrections. To prevent these types of corrections, a 60% line 52 is also inserted into the diagram 36, since, with an annual emission of below 60% of the declared emission, fewer emission rights are allocated for the following year.

FIG. 3 shows a simplified screen view in respect of the display boxes 48, as is provided for a pure electricity generation system without district heating.

1-14. (canceled)

15. A method for monitoring an emission situation of a plant emitting emissions, comprising:
determining a current emission value of the plant;
extrapolating a predicted emission value based on the current emission value;
comparing the predicted emission value with an assigned emission right;
evaluating the comparison as a basis for a further rule of the plant; and
generating an early warning based on the evaluation.

16. The method as claimed in claim 15, wherein the early warning indicates an expected surplus with an emission right above a predefined threshold value.

17. The method as claimed in claim 15, wherein the early warning indicates an expected shortfall in an emission right below a predefined threshold value.

18. The method as claimed in claim 15, wherein the early warning is indicated by a traffic light circuit.

19. The method as claimed in claim 15, wherein the early warning is automatically and wirelessly transmitted.

20. The method as claimed in claim 15, wherein the early warning comprises a display of a progression of the current emission value.

21. The method as claimed in claim 15, wherein the early warning comprises a display of a progression of the predicted emission value.

22. The method as claimed in claim 15, wherein the early warning comprises a display of a progression of the assigned emission right.

23. The method as claimed in claim 15, wherein the early warning comprises a display of a further technical data of the plant.

24. The method as claimed in claim 23, wherein the further technical data of the plant comprises an energy quantity generated by the plant.

25. A device for monitoring an emission situation of a plant emitting emissions, comprising:
a determination device for determining a current emission value of the plant;
a computing device for extrapolating a predicted emission value based the current emission value;
a comparison device for comparing the predicted emission value with an assigned emission right;
an evaluation device for evaluating the comparison as a basis for a further regulation of the plant; and
an early warning device for generating an early warning based on the evaluation.

26. The device as claimed in claim 25, wherein the early warning device indicates an expected surplus with an emission right above a predefined threshold value.

27. The device as claimed in claim 25, wherein the early warning device indicates an expected shortfall in an emission right below a predefined threshold value.

28. The device as claimed in claim 25, further comprising a traffic light device for displaying the early warning.

29. The device as claimed in claim 25, wherein the early warning is automatically and wirelessly transmitted.

30. The device as claimed in claim 25, wherein the early warning comprises a display of a progression of the current emission value.

31. The device as claimed in claim 25, wherein the early warning comprises a display of a progression of the predicted emission value.

32. The device as claimed in claim 25, wherein the early warning comprises a display of a progression of the assigned emission right.

33. The device as claimed in claim 25, wherein the early warning comprises a display of a further technical data of the plant.

34. The device as claimed in claim 33, wherein the further technical data of the plant comprises an energy quantity generated by the plant.
